(19) United States
(12) Patent Application Publication
(10) Pub. No.: US 2006/0057030 A1
(43) Pub. Date: Mar. 16, 2006

(54) Fluid transport device and disposable chip having the same

(76) Inventors: Jae-yong Lee, Seongnam-si (KR); Hye-jung Cho, Anyang-si (KR)

Correspondence Address: CANTOR COLBURN, LLP, 55 GRIFFIN ROAD SOUTH, BLOOMFIELD, CT, 06002, US

(21) Appl. No.: 11/226,117

(22) Filed: Sep. 14, 2005

(30) Foreign Application Priority Data
Sep. 14, 2004 (KR) 2004-73255

(51) Int. Cl. B01L 3/00

(52) U.S. Cl. 422/100

(57) ABSTRACT

Disclosed is a simple-structured fluid transport device. The fluid transport device for creating a fluid flow includes a base provided with a reservoir for storing a fluid; and a driving unit configured on the base for transferring a pressure, induced by an external force applied to the driving unit, to the fluid in the reservoir and thereby causing the fluid to flow.

This application claims priority to Korean Patent Application No. 2004-73255, filed on Sep. 14, 2004, and all the benefits accruing therefrom under 35 U.S.C. §119, the entire contents of which are incorporated herein by reference.

### BACKGROUND OF THE INVENTION

1. Field of the Invention

The present invention relates in general to a disposable chip such as a bio-chip and, more specifically, to a fluid transport device for making a fluid such as samples or reagents flow and a disposable chip having the same.

2. Description of the Related Art

The remarkable technical advances and improvements in micro machining of recent years have brought the development of MEMS (Micro-Electro Mechanical System). The applications of MEMS include genetic engineering, medical diagnosis, and development of new drugs. In recent years, the introduction of a new concept, “LOC (Lab on a Chip),” miniaturizing all chemical procedures associated with chemical reactions and analyses on a single fingernail-sized computer chip, has been pushed forward by the development of the MEMS.

Important applications of LOCs include bio-chips for obtaining all necessary information by treating a biosample such as blood, urine, cell, and saliva with various kinds of reagents, and micro chemical analysis systems. After a sample analysis is performed, the bio-chips or micro chemical analysis systems are usually dumped because their insides become contaminated from the sample analysis. Therefore, the bio-chips and the micro chemical analysis systems are disposable chips and cannot be recycled.

In order to drive the chips or the systems, it is necessary to make the fluid of samples or reagents flow in micro liter units. To this end, a driving source is required. Examples of existing driving sources currently used include piezo disk micro pumps, electrostatic micro pumps, and thermal micro pumps. Moreover, when a micro pump comes into direct contact with a sample or a reagent, the sample or the reagent becomes contaminated and therefore cannot be used again. Thus, a pneumatic pump capable of flowing sample or reagent fluid without making direct contact with the sample or reagent is needed.

In addition, the aforementioned micro pumps pose other problems. For example, they have very complicated structures and large volumes using other attachments besides the pump, and the micro pneumatic pump cannot generate a force strong enough to make the fluid flow.

As a result of the above mentioned problems, a micro pump (having a complicated structure) is not appropriate for use with a miniaturized disposable chip, such as bio-chips or micro chemical analysis systems, not only because it is difficult to implement but also because the prices of such products that use the expensive micro pumps are increased.

### SUMMARY OF THE INVENTION

It is therefore an object of the present invention to provide a simple structured, low-cost fluid transport device and a disposable chip having the same.

To achieve the above and other objects and advantages, there is provided a fluid transport device including: a base provided with a reservoir for storing a fluid; and a driving unit configured on the base for transferring a pressure induced by an external force to the fluid in the reservoir and thereby causing the fluid to flow.

The driving unit may include a chamber filled with gas at a predetermined size and pressure; and a gas passage for transferring gas pressure generated in the chamber to the reservoir.

The gas passage may include a first constricted portion, which initially seals the gas within the chamber and which is opened by an application of a gas pressure above a predetermined level.

The fluid transport device may further include a channel formed within the base for receiving the fluid flow therein; and a valve for fluidly connecting the channel to the reservoir.

The valve may include a second constricted portion that is opened by an application of a fluid pressure above a predetermined level.

The driving unit and the valve may be formed by adhering two layers of polymer film.

Another aspect of the present invention provides a disposable chip including: a base having a sample reservoir for storing a sample, at least one reagent reservoir for storing reagents, and at least one channel in which the sample and the reagent are mixed together and transported; a sample driving unit configured on the base for transferring a pressure, induced by an external force applied to the sample driving unit, to the sample reservoir and thereby causing the sample to flow; a reagent driving unit configured on the base for transferring a pressure induced, from an external force applied to the reagent driving unit, to the reagent reservoir and thereby causing the reagent to flow; and a plurality of valves for connecting the channel with the sample reservoir, and the channel with the reagent reservoir, respectively.

### BRIEF DESCRIPTION OF THE DRAWINGS

The above aspects and features of the present invention will be more apparent by describing certain embodiments of the present invention with reference to the accompanying drawings, in which:

FIG. 1 is a schematic plan view of an exemplary embodiment of a bio-chip according to the present invention;

FIG. 2 is a schematic perspective view of an exemplary embodiment of a fluid transport device for facilitating a fluid flow for use in a bio-chip according to the present invention;

FIG. 3 is a cross-sectional view taken along the line III-III in FIG. 2; and

FIG. 4A to FIG. 4C are cross-sectional views illustrating the operation of an exemplary embodiment of a fluid transport device for facilitating a fluid flow for use in a bio-chip according to the present invention.

### DETAILED DESCRIPTION OF THE INVENTION

A preferred embodiment of the present invention will be described herein below with reference to the accompanying drawings.

It will be understood that when an element or layer is referred to as being “on”, “connected to” or “coupled to” another element or layer, the element or layer can be directly on, connected or coupled to another element or layer or intervening elements or layers. In contrast, when an element is referred to as being “directly on,” “directly connected to” or “directly coupled to” another element or layer, there are no intervening elements or layers present. Like numbers refer to like elements throughout. As used herein, the term “and/or” includes any and all combinations of one or more of the associated listed items.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

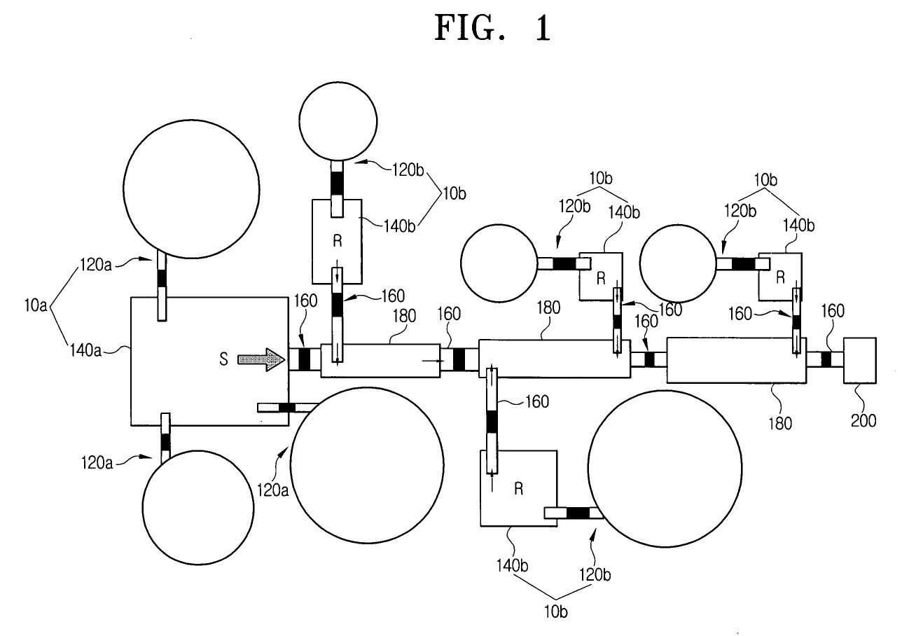

FIG. 1 is a schematic plan view of an exemplary embodiment of a bio-chip to which a fluid transport device is applied.

Referring to FIG. 1, the bio-chip of the present invention includes a sample transport unit 10a, and a plurality of reagent transport units 10b.

The sample transport unit 10a transports a sample S to be tested. A sample S is injected into a single sample reservoir 140a, to which three sample driving units 120a are connected. Each of the sample driving units 120a is filled with gas of different pressures and volumes, in order to transfer an adequate pressure for transporting the sample S from the sample reservoir 140a. Although three sample driving units 120a are depicted in this particular embodiment, it will be appreciated that the number of sample driving units 120a may be varied, depending on the level of pressure required for fluidly transporting the sample S.

The reagent transport unit 10b transports a reagent R for treating the sample S. In an exemplary embodiment, a single reagent driving unit 120b is connected to a plurality of reagent reservoirs. If needed, however, a plurality of reagent driving units 120b can be connected to a single reagent reservoir 140b. Each of the reagent driving unit 120b is filled with gas of different pressures and volumes, depending on the quantity of reagent R required.

The sample and the reagent reservoirs 140a, 140b are connected to one end of valves 160, respectively, and the other ends of the valves 160 are connected to a plurality of channels 180 for transporting and mixing the sample S and the reagent(s) R.

Therefore, the sample S, through the use of the sample driving unit 120a, flows into the channel 180 via the valve 160. Similarly, the reagent R also flows into the channel 180 through the use of the reagent driving unit 120b. The sample S and the reagent R are thereby mixed together and undergo chemical treatment within the first channel 180. Later, the chemically treated mixture is sent to second and third channels 180 and undergoes chemical treatments with different reagents R, respectively. Finally, the chemically treated sample S is transported to a sensor 200, through which information on the sample S is obtained.

The sample and reagent transport units 10a, 10b have the same configuration and operation. Accordingly, the sample and reagent transport units 10a, 10b will hereinafter be referred to simply as a flow transport unit 10.

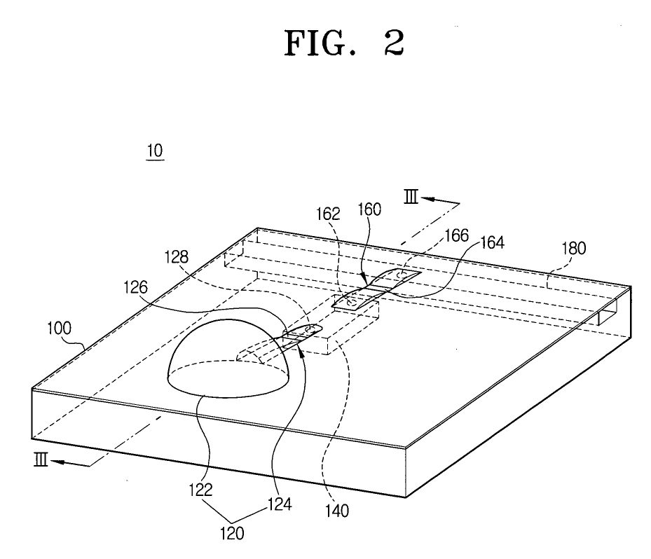

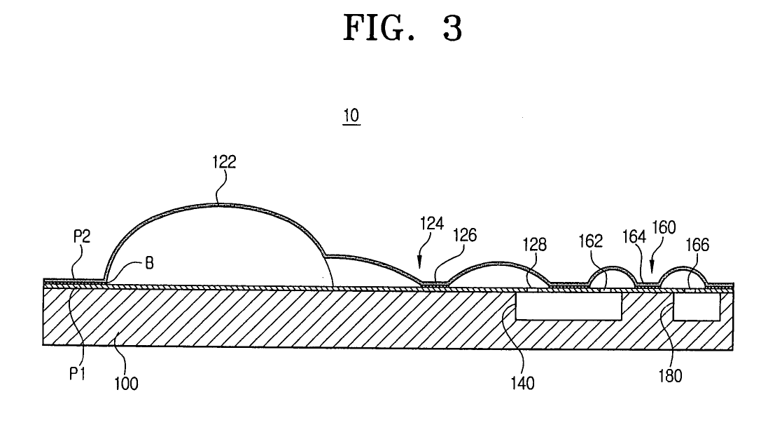

FIG. 2 is a schematic perspective view of an exemplary embodiment of a fluid transport device for use in a bio-chip according to the present invention, and FIG. 3 is a cross-sectional view taken along the line III-III in FIG. 2.

Referring to FIGS. 2 and 3, the fluid transport device 10 includes a base 100, a driving unit 120 installed on the top of the base 100, a reservoir 140 formed within the base 100 to be connected to the driving unit 120, a valve 160 installed on the top of the base 100 to be connected to the reservoir 140, and a channel 180 formed in the base 100 to be connected to the valve 160. In the embodiment shown, the reservoir 140 and the channel 180 are depressed into the base 100, and the driving unit 120 and the valve 160 are formed between polymer films (e.g., polyethylene) P1, P2 that are attached to one side of the base 100.

The base 100 is formed from small, solid boards made of glass, silicon or nylon, for example. The two layers of polymer film P1, P2 are attached to the top surface of the base 100 through an adhesive B, such as a glue for example.

The driving unit 120 includes a chamber 122 filled with gas at a certain pressure, and a gas passage 124 in fluid communication with the chamber 122.

The chamber 122 is formed by filling the space between the two layers of film P1, P2 with gas at a certain pressure. As can be seen in the drawing, the chamber 122 is characterized by a bubble like structure. One suitable example of the material used for chamber 122 is AirCap®, which is a protective bubble cushioning material typically used in packing or shipping boxes for protecting products from damage caused by shock and vibration. In the present application, various kinds of gases (including air, for example) may be used within the fluid transport device, so long as they do not contaminate or change quality of samples and reagents. Even though the chamber 122 in this particular embodiment is made of polymer films P1, P2, other materials can also be used for the chamber 122 (e.g., rubber) so long as the material is flexible and elastic enough to be pressed by external force. Therefore, the pneumatic pressure created in the chamber 122 may be used very advantageously to initiate the fluid flow. Thus, the fluid transport device of the present embodiments are at least equally as effective as the conventional micro pumps, in terms of initiating the fluid flow. Moreover, the use of the fluid transport devices of the present application, in lieu of the more expensive micro pumps, can lower current product prices.

Referring still to FIGS. 2 and 3, a through hole 128 is formed in the gas passage 124 so that one end of the gas passage 124 is in communication with the chamber 122 and the other end is in communication with the reservoir 140. In addition, a constricted portion 126 is formed proximate the center of the both ends of the gas passage 124, in order to initially seal the gas within the chamber by preventing gas leakage from the chamber 122 into the reservoir 140. The constricted portion 126 may be formed by adhering the two layers of film P1, P2 using an adhesive, or pressing the films together by applying heat or pressure. If the pressure inside the chamber 122 rises above a predetermined level, the two layers of film P1, P2 will become separated and the constricted portion 126 is opened spontaneously.

As aforementioned, the reservoir 140 is depressed into the base 100 for storing fluid of a sample to be analyzed, or for storing a reagent for chemically treating the sample. The entire top surface of the reservoir 140, except for a through hole 162 for communicating the through hole 128 with the valve 160 on the other side, is covered up tightly by the two layers of film P1, P2.

Two through holes 162, 166 are formed on both ends of the valve 160 for fluidly connecting the reservoir 140 and the channel 180. As is the case for gas passage 124, a constricted portion 164 is formed proximate the center of the valve 160. This constricted portion 164 is formed using the same method as the constricted portion 126 in the gas passage 124. As is also the case with gas passage 124, the two layers of film P1, P2 attached to the constricted portion 164 will become separated from each other and opened up if a pressure greater than a predetermined pressure for the fluid stored in the reservoir 140 is applied.

As described above, the channel 180 is depressed into the base 100, and communicates with the valve 160 by the through hole 166 which is formed on one end of the valve 160. The channel 180 can be used as a fluid passage, or as a mixing chamber for mixing a sample and a reagent.

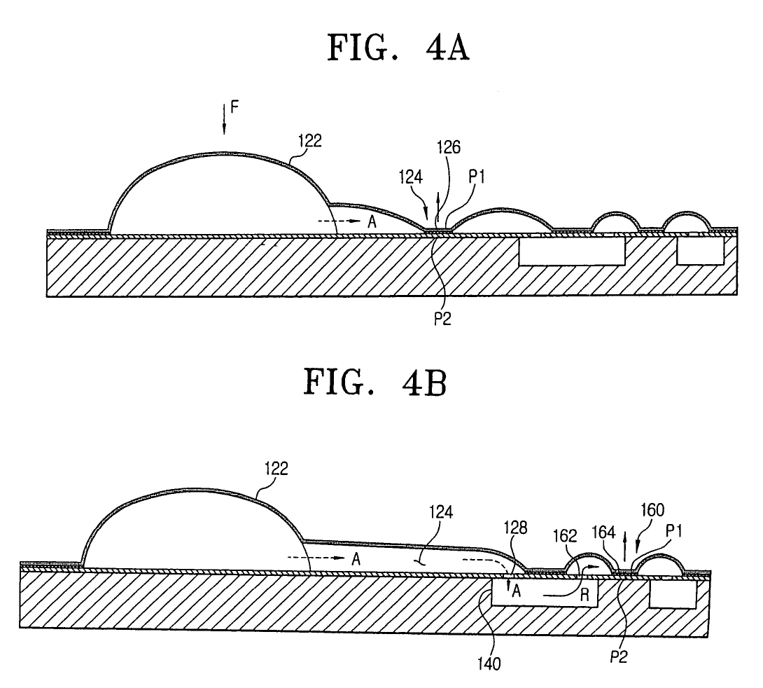

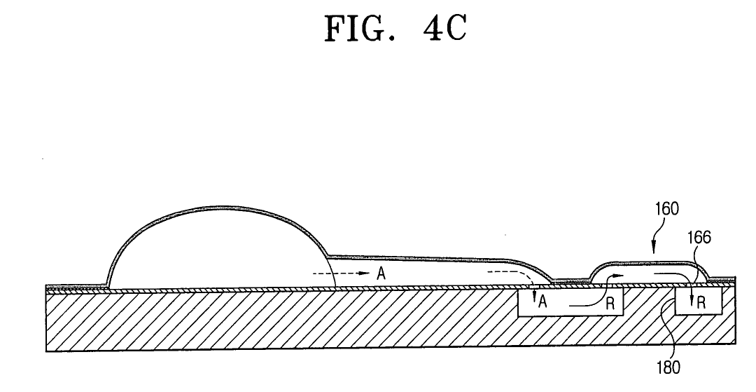

Referring now to FIGS. 4A through 4C, the operation of the fluid transport device for use in the bio-chip will now be explained, according to one embodiment of the present invention. In FIGS. 4A to 4C, a dotted line arrow indicates a gas flow, whereas a solid line arrow indicates a fluid flow.

As can be seen in FIG. 4A, a bio-chip user applies an external force F to the chamber 122 (such as through pressing by hand or through particular equipment) to make the sample or the reagent flow. As a result of the user applied force F, the compressed gas “A” inside the chamber 122 moves towards the constricted portion in the gas passage 124, applying a certain pressure thereto. This pressure in turn results in the two layers of film P1, P2 attached to the constricted portion 126 becoming separated from each other, and the gas passage 124 is thereby opened.

As shown in FIG. 4B, once the gas passage 124 is opened, the gas “A” inside the chamber 122 passes through the through hole 128 formed in the gas passage 124 and into the reservoir 140. Then, the fluid R, which has been stored in the reservoir 140, starts flowing (i.e., is displaced) by the pressure provided from the gas. This fluid passes through the through hole 162 formed on one end of the valve 160 and flows to the constricted portion 164 of the valve 160. The pressure of the fluid is then applied to the constricted portion 164 and as a result, the two layers of film P1, P2 attached to the constricted portion 164 are separated from each other and the valve 160 is thereby opened.

Referring to FIG. 4C, once the valve 160 is opened, the fluid R flows into the channel 180 via the through hole 166 formed on the other end of the valve 160. The fluid R entering the channel 180 the fluid is then mixed with another fluid so as to undergo a chemical treatment. Subsequently, the reacted fluid flows into another channel to be mixed with another reagent therein, so as to be further chemically treated.

As will be appreciated, the simple-structured fluid transport device, using the above described prepared pneumatic pressure approach is advantageous with respect to the more complicated pneumatic micro pump. In return, it is now possible to manufacture low-cost disposable chips.

Moreover, the structure of the fluid transport device is so simple that any ordinary person may easily handle disposable chips without using other equipment or devices.

The foregoing embodiment and advantages are merely exemplary and are not to be construed as limiting the present invention. The present teaching can be readily applied to other types of apparatuses. Also, the description of the embodiments of the present invention is intended to be illustrative, and not to limit the scope of the claims, and many alternatives, modifications, and variations will be apparent to those skilled in the art.

What is claimed is:

1. A fluid transport device comprising:
a base provided with a reservoir for storing a fluid; and
a driving unit configured on the base for transferring a pressure, induced by an external force applied to the driving unit, to the fluid in the reservoir and thereby causing the fluid to flow.

2. The device according to claim 1, wherein the driving unit comprises:
a chamber filled with gas at a predetermined size and pressure; and
a gas passage for transferring gas pressure generated in the chamber to the reservoir.

3. The device according to claim 2, wherein the gas passage comprises a first constricted portion, which initially seals the gas within the chamber and which is opened by an application of a gas pressure above a predetermined level.

4. The device according to claim 3, further comprising:
a channel formed within the base for receiving the fluid flow therein; and
a valve for fluidly connecting the channel to the reservoir.

5. The device according to claim 4, wherein the valve comprises a second constricted portion that is opened by an application of a fluid pressure above a predetermined level.

6. The device according to claim 4, wherein the driving unit and the valve are formed by adhering two layers of polymer film.

7. The device according to claim 2, wherein the gas comprises air.

8. The device according to claim 3, wherein the first constricted portion is located approximately midway between opposing ends of the gas passage.

9. The device according to claim 5, wherein the second constricted portion is located approximately midway between opposing ends of the valve.

10. The device according to claim 4, wherein the chamber, the gas passage and the valve are bubble shaped.

11. A disposable chip comprising:
a base having a sample reservoir for storing a sample, at least one reagent reservoir for storing reagents, and at least one channel in which the sample and the reagent are mixed together and transported;
a sample driving unit configured on the base for transferring a pressure, induced by an external force applied to the sample driving unit, to the sample reservoir and thereby causing the sample to flow;
a reagent driving unit configured on the base for transferring a pressure, induced by an external force applied to the reagent driving unit, to the reagent reservoir and thereby causing the reagent to flow; and
a plurality of valves for fluidly connecting the channel with the sample reservoir, and the channel with the reagent reservoir, respectively.

12. The disposable chip according to claim 11, wherein the sample driving unit comprises:
at least one chamber filled with gas at a predetermined size and pressure; and
a first gas passage for transferring gas pressure generated in the chamber to the sample reservoir.

13. The disposable chip according to claim 12, wherein the first gas passage comprises a first constricted portion, which initially seals the gas within the chamber and which is opened by an application of a gas pressure above a predetermined level.

14. The disposable chip according to claim 11, wherein the reagent driving unit comprises:
at least one chamber filled with gas at a predetermined size and pressure; and
a second gas passage for transferring gas pressure generated in the chamber to the reagent reservoir.

15. The disposable chip according to claim 14, wherein the second gas passage comprises a second constricted portion, which initially seals the gas within the chamber and which is opened by an application of a gas pressure above a predetermined level.

16. The disposable chip according to claim 11, wherein the valve comprises a constricted portion that is opened by an application of a sample or reagent fluid pressure above a predetermined level.

17. The disposable chip according to claim 12, wherein the gas comprises air.

18. The disposable chip according to claim 13, wherein the first constricted portion is located approximately midway between opposing ends of the first gas passage of the driving unit.

19. The device according to claim 15, wherein the second constricted portion is located approximately midway between opposing ends of the second gas passage of the reagent driving unit.

20. The device according to claim 14, wherein the chamber of the sample driving unit, the first gas passage, the chamber of the reagent driving unit, and the second gas passage are bubble shaped.
